(19) United States
(12) Patent Application Publication
(10) Pub. No.: US 2011/0047450 A1
(43) Pub. Date: Feb. 24, 2011

(54) METHOD OF PROVIDING DOCUMENT BOX AS WEB PAGE AND IMAGE FORMING APPARATUS TO PERFORM THE SAME

(75) Inventors: Sang-hyun PARK, Suwon-Si (KR); Sang-jin Lee, Suwon-Si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/788,628

(22) Filed: May 27, 2010

(30) Foreign Application Priority Data
Aug. 21, 2009 (KR) 2009-77869

(51) Int. Cl. G06F 17/00; G06F 15/16

(52) U.S. Cl. 715/234; 709/203

(57) ABSTRACT

A method of providing at least one document box as a web page includes creating at least one document box, storing at least one document in the at least one created document box, creating a web page to correspond to the at least one document box, converting the at least one document stored in the at least one document box into image data having an image form to represent the at least one document as the web page, and providing at least one of the created web page and the converted image data in response to a request of a client.

### CROSS-REFERENCE TO RELATED APPLICATIONS

This application claims priority under Korean Patent Application No. 10-2009-0077869, filed on Aug. 21, 2009, in the Korean Intellectual Property Office, the disclosure of which is incorporated herein in its entirety by reference.

### BACKGROUND

1. Field of the Invention

The present general inventive concept relates to a method of providing a document box as a web page and an image forming apparatus to perform the method.

2. Description of the Related Art

Image forming apparatuses which perform at least one of the functions including printing, copying, scanning, faxing and e-mailing a document, and sending a document to servers may use a document box to perform the various functions. Users may easily and conveniently manage data stored in the image forming apparatuses and created during the performing of functions including printing, faxing, scanning, and copying by using the document box. That is, the users may use the document box to perform tasks including printing, e-mailing and faxing a document and sending a document to servers for the data stored in the image forming apparatuses at a user's desired time.

### SUMMARY

The present general inventive concept provides a method of providing a document box in an image forming apparatus as a web page and an image forming apparatus to perform the method.

Additional features and utilities of the present general inventive concept will be set forth in part in the description which follows and, in part, will be obvious from the description, or may be learned by practice of the general inventive concept.

According to an aspect of the present general inventive concept may be realized by a method of providing at least one document box stored in an image forming apparatus and at least one document stored in the document box as a web page, the method including creating the at least one document box, storing the at least one document in the at least one created document box, creating a web page that corresponds to the at least one document box, converting the at least one document stored in the at least one document box into image data having an image form to represent the at least one document as the web page, storing the created web page and the image data in a location corresponding to the web page in the image forming apparatus, and providing at least one selected from the group consisting of the stored web page and the stored image data in response to a request of a client.

According to another aspect of the present general inventive concept may also be realized by an image forming apparatus including at least one document box, the apparatus including a document box creator which creates the at least one document box, a web page creator which creates a web page that corresponds to the at least one document box, a converter which converts at least one document stored in the at least one document box into image data having an image form to represent the at least one document as the web page, a storage unit which stores the at least one document in the at least one created document box, and stores the created web page and the image data in a location corresponding to the web page, and a communication interface unit which provides at least one selected from the group consisting of the stored web page and the stored image data in response to a request of a client.

### BRIEF DESCRIPTION OF THE DRAWINGS

The above and other features and utilities of the present general inventive concept will become more apparent by describing in detail exemplary embodiments thereof with reference to the attached drawings in which:

FIGS. 1A-1D are block diagrams of an image forming system according to embodiments of the present general inventive concept;

FIG. 2 illustrates a graphic user interface (GUI) of an image forming apparatus to select a document box according to an embodiment of the present general inventive concept;

FIG. 3 illustrates a GUI of an image forming apparatus to provide a web page which corresponds to a selected document box according to an embodiment of the present general inventive concept;

FIG. 4 illustrates web page addresses according to an embodiment of the present general inventive concept;

FIG. 5 illustrates a selection screen to select layout information according to an embodiment of the present general inventive concept;

FIG. 6 illustrates a list of web pages according to an embodiment of the present general inventive concept;

FIG. 7 is a flowchart illustrating a method of providing documents included in a document box as a web page according to an embodiment of the present general inventive concept;

FIG. 8 is a flowchart illustrating a method of providing documents included in a document box as a web page in consideration of the capacity of the documents according to an embodiment of the present general inventive concept;

FIG. 9 illustrates that a document box is represented as a web page according to an embodiment of the present general inventive concept;

FIGS. 10A and 10B illustrate flow charts of methods of displaying image data according to embodiments of the present general inventive concept; and

FIG. 11 illustrates a host according to an embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

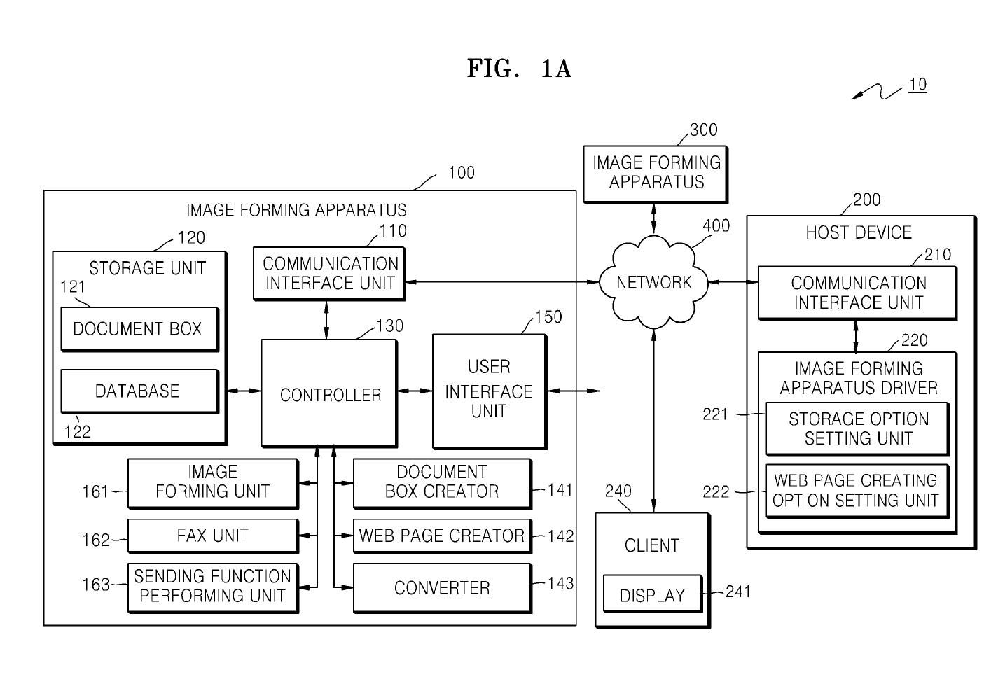

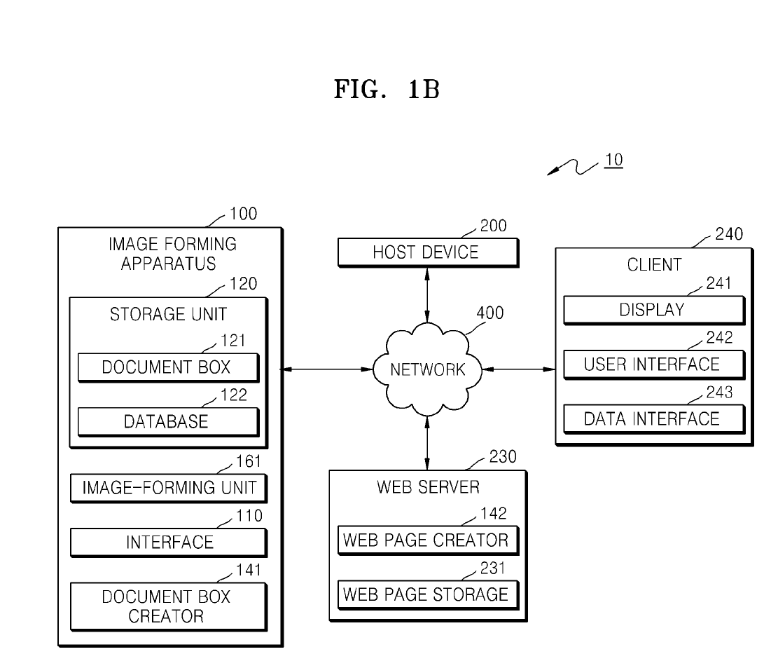

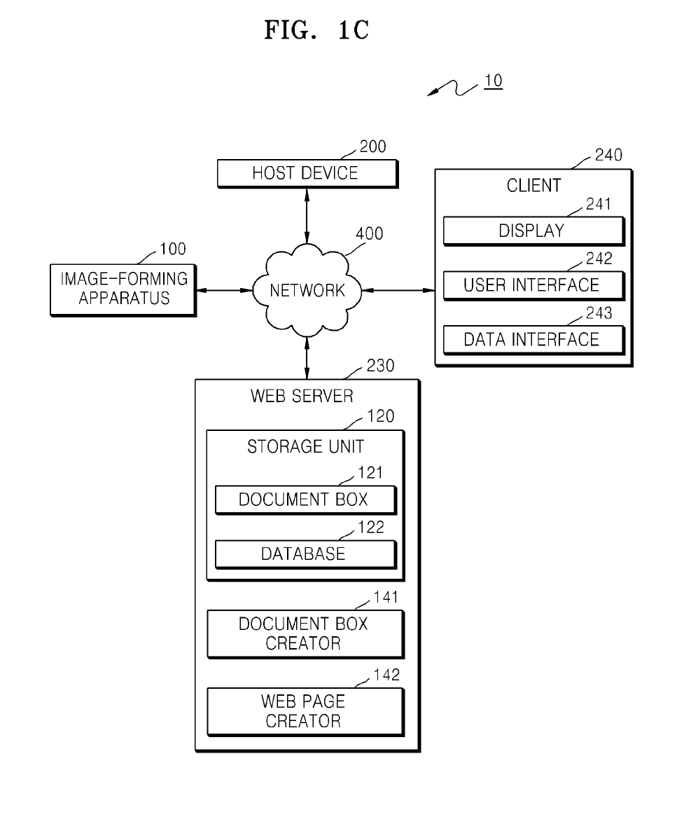

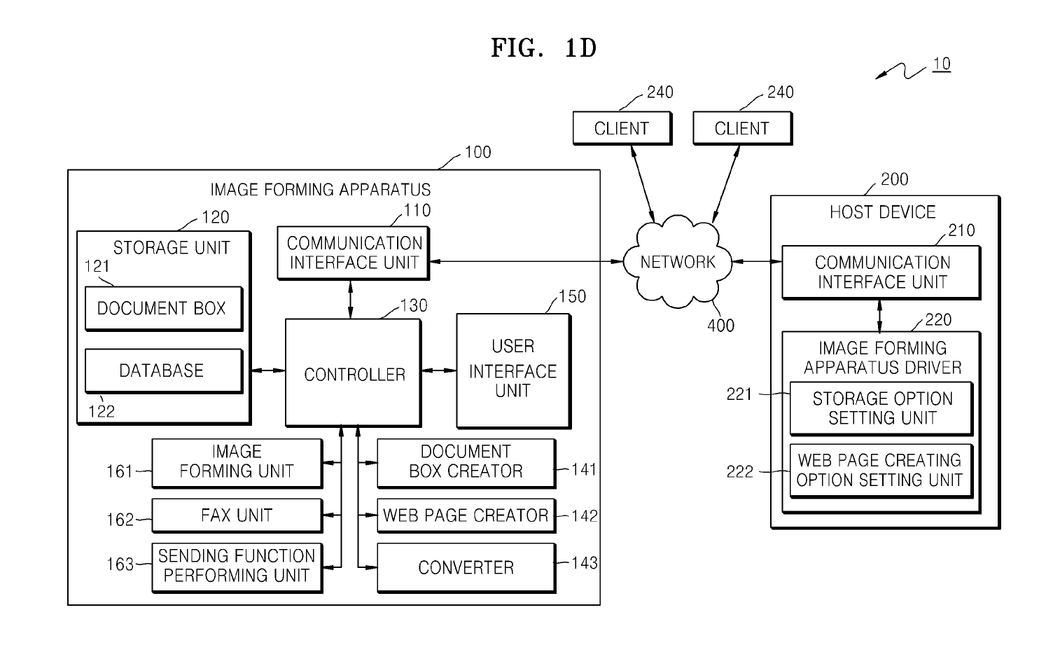

FIG. 1A is a block diagram of an image forming system 10 according to an embodiment of the present general inventive concept. Referring to FIG. 1, the image forming system 10 includes an image forming apparatus 100, a host device 200 connected to the image forming apparatus 100 through a network 400, and another image forming apparatus 300 connected to the image forming apparatus 100 through the network 400. The image forming system 10 may include only one host device 200 and the image forming apparatuses 100 and 300. However, the present general inventive concept is not limited thereto and the image forming apparatus 100 may be connected to a plurality of host devices 200 or a plurality of other image forming apparatuses 300.

The image forming apparatus 100 includes a communication interface unit 110, a storage unit 120, a controller 130, a document box creator 141, a web page creator 142, a converter 143, a user interface unit 150, an image forming unit 161, a fax unit 162, and a sending function performing unit 163, and the storage unit 120 includes a document box 121 and a database 122.

In the specification, only elements relating to the current embodiment are described so as not to hinder the understanding of the present general inventive concept. Thus, one of ordinary skill in the art to which the present general inventive concept pertains will understand that other commonly used elements, in addition to the elements illustrated in FIG. 1, may be further included in the image forming system 10, image-forming apparatus 100, and host device 200. For example, each of the image-forming apparatus 100, host device 200, and client 240 may include processors, memory to store data, logic to perform processing operations, controllers, and interfaces to communicate electronically with other devices and to connect with the network 400. In addition, the host device 200 may be the client 240. In such a case, the host device 200 may include a display 241 to display image data or a web page, as will be explained below.

The image forming apparatus 100 includes at least one document box 121 and at least one document stored in the document box 121 as a web page. The controller 130 may create a database 122 of information used to represent the document box 121 as a web page in a region of the storage unit 120. The web page may be generated using Hyper Text Markup Language (HTML), eXtensible Hypertext Markup Language (XHTML), Cascading Style Sheet (CSS), JaveScript, pictures, and Flash which are displayed on a display of a client that requests the web page. For example, the client may request a web page from a web server through HyperText Transfer Protocol (HTTP) by using a web browser, which is an example of a web application, and the web server may provide the web page to the client in response to the request. Information provided from the web server is interpreted by the web browser and is displayed on a display 241 of the client 240, and this is called a web page.

The web page may be an interface generated in the image-forming apparatus 100 and transmitted to the client 240 to be displayed on a display 241 together with the image data. In addition, a programming language used to generate the web page according to the current embodiment includes a markup language and a web programming language.

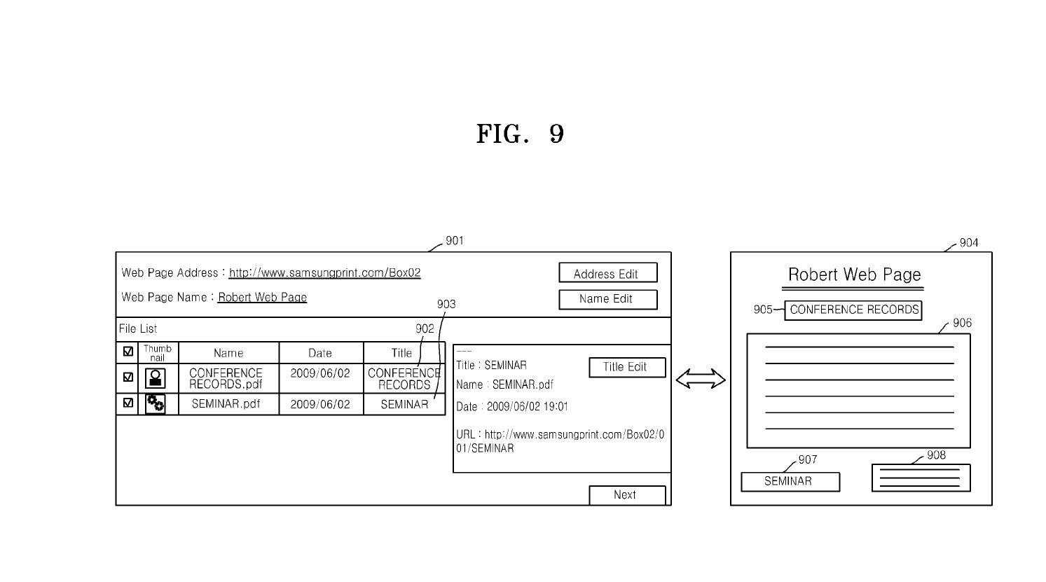

The image forming apparatus 100 may perform the web server function. That is, the storage unit 120 of the image forming apparatus 100 may include a web server (not shown) which provides the web page in response to the request of the client, such as the host device 200 or a separate client 240. The image forming apparatus 100 provides the web page to the client 240 in response to the request of the client 240 to view the documents stored in the image forming apparatus 100 as a web page. For example, as illustrated in FIG. 9, the web page creator 142 creates a web page, the converter 143 converts the documents stored in the document box 121 of the image forming apparatus 100 into a web page, and the storage unit 120 stores the created web page and converted data. When the client 240 requests the web page, the controller 130 provides information stored in the storage unit 120 to the client 240 through the communication interface unit 110 and a web page 904 illustrated in FIG. 9 is displayed on a display 241 of the client 240.

The client 240 may be a PC or any other computing device capable of connecting to the network 400 and communicating with the image-forming apparatus 100 and also capable of displaying a web page. The client 240 may be connected to the network 400 or the image-forming apparatus 100 via wired or wireless communication.

The image forming apparatus 100 may provide the documents stored in the document box 121 to the client 240 as a web page according to the method above. Hereinafter, various embodiments to provide the web page are described in relation to the elements illustrated in FIG. 1.

The communication interface unit 110 transmits and receives data to and from an external device, such as the host device 200 or a client 240, through the network 400. The communication interface unit 110 may include a modem to send and receive a fax, a network module to connect to a network 400, and an USB host module to communicate with a mobile storage medium, according to the functions of the image forming apparatus 100. The communication interface 110 may further include any communication port to transmit data, including a wireless transceiver to wirelessly transmit and receive data.

An external device, such as the host device 200, client 240, or other image-forming apparatus 300 may be connected to the image forming apparatus 100 via a wired or wireless network 400 and may include a fax machine, a computer system, a mobile device, a personal digital assistant (PDA), or a server. Also, the network 400 may correspond to the Internet, a Local Area Network (LAN), a Wireless LAN, or a Wide Area Network (WAN), or any other type of electronic network.

The communication interface unit 110 receives data used to provide the document box 121 to a web page from the external device or transmits data to form a web page in response to the request of the client 240.

For example, when the communication interface unit 110 receives printing data from the host device 200 that is connected to the image forming apparatus 100, the controller 130 stores the received printing data in the document box 121 having an attribute of the received printing data from among a plurality of document boxes 121. Here, the attribute includes a user ID of the host device 200 which sends the printing data and an ID of the host device 200. In other words, the controller 130 may store each document having a user ID of the host device 200 in a same document box 121. In addition, a single document may be stored in multiple document boxes 121.

The host device 200 may be a PC, server, portable computing device, or other computing device connected to the image-forming apparatus 100 and capable of providing image-forming data to the image-forming apparatus 100. For example, if the host device is a PC, a user may generate an image or document and send the generated image or document to the image-forming device 100 to be printed or published to a web page.

When the client 240 inputs a Uniform Resource Locator (URL) indicating the document box 121 to view the documents included in the document box 121 as a web page, the communication interface unit 110 provides information of the storage unit 120 stored in a corresponding location of the URL to the client 240.

The storage unit 120 stores therein at least one document box 121, at least one document stored in the document box 121, and the database 122 including information to represent the at least one document box 121 in a web page form. In addition, the storage unit 120 may further include a program memory (not illustrated) and a data memory (not illustrated). In the program memory, a program to control a general operation of the image forming apparatus 100 is stored. In the data memory, data created during executing programs is temporarily stored.

The storage unit 120 may be a general storage medium and may include a hard disk drive (HDD), random access memory (RAM), flash memory, a memory card, or any other data storage medium.

The document box 121 includes at least one document which may be formed or transmitted via printing, copying, scanning and faxing, and sending and receiving the at least one document to and from a server. The at least one document included in the document box 121 may be provided to a client 240 as a web page.

The document box 121 exists in the storage unit 120. A plurality of document boxes 121 classified according to their attributes may be represented in a form of a graphic user interface (GUI) in the user interface unit 150.

The image forming apparatus 100 may perform a printing task by using the documents stored in the storage unit 120, send e-mails by attaching the documents stored in the storage unit 120, fax the documents stored in the storage unit 120, and send the documents stored in the storage unit 120 to a server (e.g., server message block/file transfer protocol). Here, the document box 121 stores the documents by classifying them according to their attributes so that a user may easily perform the tasks by using the documents stored in the storage unit 120 at a user's desired time. Accordingly, the image forming apparatus 100 may provide web pages which correspond to the document boxes 121 classified by their attributes.

The document boxes 121 classified by their attributes may include a public box or a secure box. The public box may be available to any user of the image-forming system 10 and a secure box may be available to only some users, such as users of a particular client 240 or users who enter a certain password. The document box 121 may include a plurality of document boxes 121 that are classified by users.

The database 122 includes information to represent the document box 121 as a web page. The database 122 includes data to provide at least one document included in the document box 121 as a web page and manages the data. The database 122 may be formed of a database including image data converted to provide the documents in a web page form and a database including information to provide web pages corresponding to the document boxes 121. Here, the database including information to provide web pages corresponding to the document boxes 121 may correspond to a structured query language (SQL) server. The SQL server stores a high capacity of data used to operate a web site and manages the relation with the data so as to efficiently find required information. The database 122 is not limited to the SQL server and may include all means for storing and managing data to provide at least one document stored in the document box 121 as a web page.

The storage unit 120 may include the web server to provide a web page corresponding to the document box 121. That is, the document box creator 141 creates the document box 121, the web page creator 142 creates the web page corresponding to the document box 121, and the storage unit 120 stores the web page to the location corresponding to the web page. In the storage unit 120, a plurality of web pages which correspond to the plurality of document boxes 121 may be stored. That is, since the storage unit 120 stores the database 122 respectively corresponding to the web pages or regions respectively corresponding to the web pages are set in the database 122, the storage unit 120 may store and manage data for a plurality of web pages. Here, the storage unit 120 may manage the data by using addresses of the web pages set by the web page creator 142. Data forming the web page which corresponds to the address may be stored in the location corresponding to the address of the web page in the database 122.

The document box creator 141, the web page creator 142, and the converter 143 may each include processors or controllers and memory to store data, commands, and other computer programs to operate the controller 130 or task-specific controllers or processors to execute commands to generate a digital document box, generate software to display a web page on a display, and convert a digital file into a format to be displayed in a web page on a display, respectively.

The controller 130 controls the function of the entire image forming apparatus 100. That is, the controller 130 controls the communication interface unit 110, the storage unit 120, the document box creator 141, the web page creator 142, the converter 143, the user interface unit 150, the image forming unit 161, the fax unit 162, and the sending function performing unit 163. The controller 130 may control not only the entire function of the image forming apparatus 100 but may also provide a web page corresponding to the document box 121.

The document box creator 141 creates the document boxes 121. In the image forming apparatus 100 having at least one document box 121, a user may create the document boxes 121 to be provided as web pages by using the document box creator 141. A user may create the document boxes 121 by using a GUI represented in the user interface unit 150 or by using an image forming apparatus driver 220 of the host device 200 connected to the image forming apparatus 100. The storage unit 120 stores at least one document in the document box 121. Here, the at least one document may include at least one of the group consisting of scan data, fax data, e-mail data, and printing data. The scan data may be created as a result of scanning performed in the image forming apparatus 100, fax data may be created as a result of faxing performed in the image forming apparatus 100, and the e-mail data may be created as a result of sending and receiving e-mails through the image forming apparatus 100. Also, the printing data may be received from the host device 200 that is connected to the image forming apparatus 100.

The web page creator 142 creates a web page corresponding to the document box 121. The web page creator 142 sets the address of the created web page and matches a storage path of the document stored in the document box 121 with an URL of the address of the web page, and the storage unit 120 stores the address of the web page and the matching information. Thus, the client 240 may view the web page which corresponds to the document box 121 by using the address of the web page, and may copy or download the documents stored in the document box 121 by using the information stored in the storage unit 120.

The storage path of the document and a URL matching process of the web page are described in more detail as follows. When it is assumed that the storage path of the document stored in the document box 121 is “C:\root\documentbox\userbox\Robert\box02\20090602_{—}02.pdf” and an URL of the document is “http://www.samsungprint.com/Box02/001/20090602_{—}02”, the web page creator 142 matches the storage path of the document with an URL of the address of the web page and the storage unit 120 stores the matching information. Accordingly, when the client 240 inputs the URL “http://www.samsungprint.com/Box02/001/20090602_{—}02”, the web page creator 142 searches for matching information which corresponds to the URL and the client 240 may view and download the document corresponding to the URL in a web page form with reference to the storage path indicating the location of the document stored in the image forming apparatus 100 based on the searching result.

The web page creator 142 may create a web page by using the host device 200 connected to the image forming apparatus 100 or by using the user interface unit 150 of the image forming apparatus 100.

The web page may be created by using the user interface unit 150 as follows. A user selects the document box 121, in which the documents to be provided as web pages are stored, through the user interface unit 150. The user may select only one document box 121 or a plurality of document boxes 121. In this case, the document box 121 is created by the document box creator 141, and the user may select the created document box 121.

The web page creator 142 sets the address of the web page to provide the documents stored in the selected document box 121 as a web page and matches the URL of the web page with the storage path of the document stored in the document box 121. In addition, the web page creator 142 stores information about the document box 121, address information of the set web page, and matching information of the storage path of the document and the URL of the web page in the location corresponding to the web page.

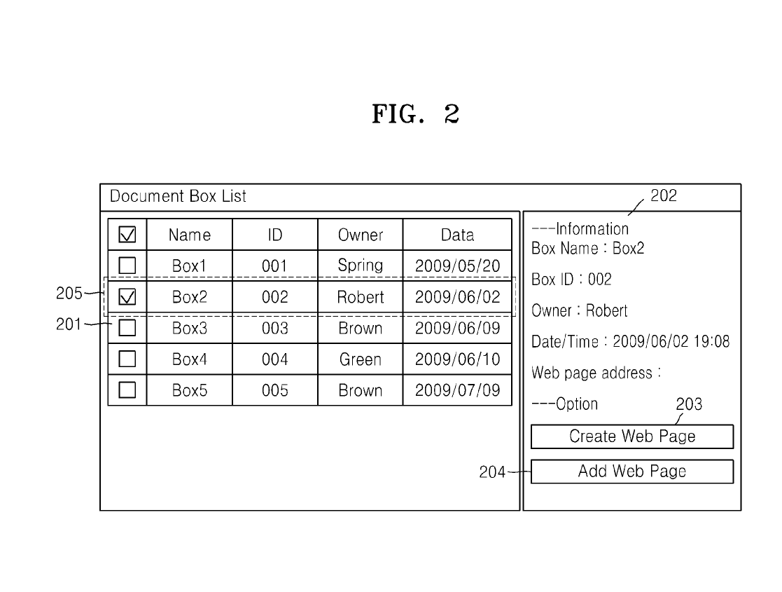

FIG. 2 illustrates a GUI of the image forming apparatus 100 to select the document box 121, according to an embodiment of the present general inventive concept.

Referring to FIG. 2, a document box list 201, an information display region 202, a web page creation icon 203, a document box addition icon 204, and a selected document box 205 are illustrated.

The document box list 201 represents a list of the document boxes 121 stored in the image forming apparatus 100. The document box list 201 is formed of the names of the document boxes 121, IDs of the document boxes 121, owners of the document boxes 121, and creation dates of the document boxes 121. For example, the selected document box 205 has the name “Box2”, the ID “002” the owner “Robert”, and the creation date of “Jun. 2, 2009”.

The information display region 202 displays the information about the selected document box 205.

A user of the image forming apparatus 100 may select any one of the document boxes included in the document box list 201 by using the user interface unit 150, and the information display region 202 displays information about the selected document box 205. Referring to FIG. 2, the information display region 202 includes the name, ID, owner, and creation date and time of the selected document box 205.

When the web page creation icon 203 is selected by the user, a selection screen for creating the web page that corresponds to the selected document box 205 is displayed on the user interface unit 150. For example, a user selects the document box to be provided as a web page from among the document boxes illustrated in the document box list 201 through the user interface unit 150, and selects the web page creation icon 203. When the web page creation icon 203 is selected, a selection screen to provide the documents included in the selected document box 205 as a web page is displayed on the user interface unit 150.

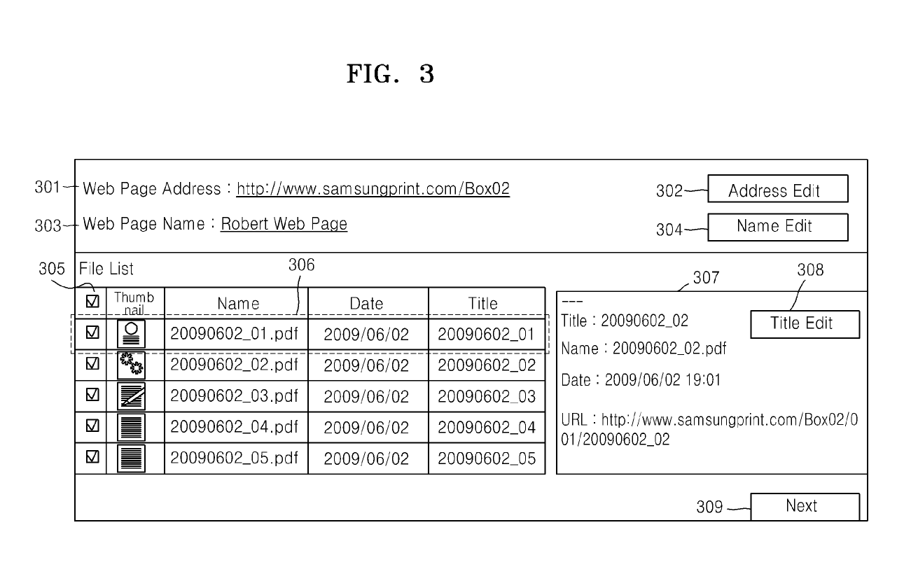

FIG. 3 illustrates a GUI of the image forming apparatus 100 to provide a web page which corresponds to the selected document box 205, according to an embodiment of the present general inventive concept.

Referring to FIG. 3, a web page address 301, an address edit icon 302, a web page name 303, a name edit icon 304, a document list 305, a selected document 306, an information display region 307, a title edit icon 308, and a next icon 309 are illustrated.

The web page address 301 represents the address of the web page to provide the selected document box 205 of FIG. 2 as the web page. The address of the web page may be automatically generated according to a predetermined method or may be generated according to a method selected by a user from among a plurality of predetermined methods. Here, the user may select the address edit icon 302 and edit a web page address.

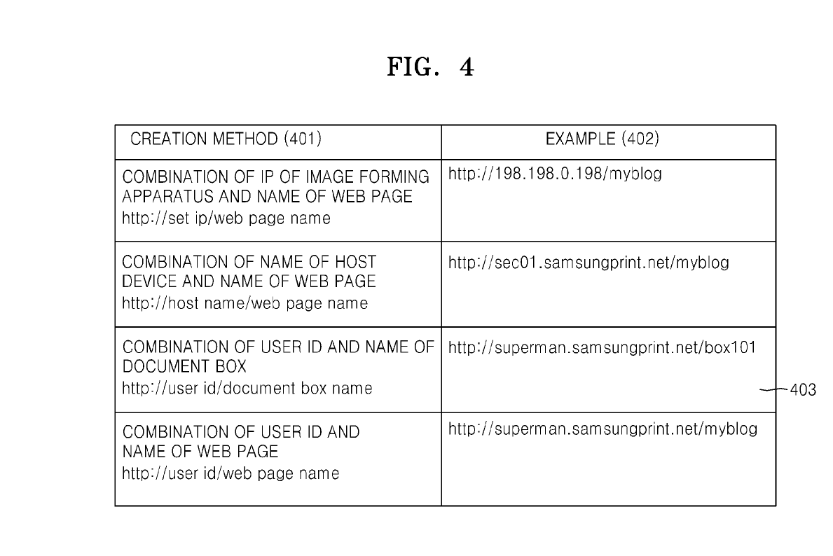

FIG. 4 illustrates web page addresses according to an embodiment of the present general inventive concept.

Referring to FIG. 4, creation methods 401 for web page addresses and examples 402 are illustrated.

The web page address may be formed of a combination of the name of the web page, the name of the host device 200 connected to the image forming apparatus 100, ID of the user of the image forming apparatus 100, and the name of the selected document box 205. In an example 403 formed of a combination of the ID of a user and the name of the document box, a web page address may be “http://user id/document box name”. When the ID of the user is “superman.samsungprint.net” and the name of the selected document box is “box101”, the web page address may be “http://superman.samsungprint.net/box101”.

That is, the web page address may be generated by using at least one of the group consisting of an IP address of the image forming apparatus 100, identification information such as user ID of the image forming apparatus 100 or the host device 200, attributes of documents provided in a web page form, and the storing location of the document box 121 provided as a web page. Here, the storing location of the document box 121 indicates the storage path of the document box 121 in the image forming apparatus 100.

The web page address illustrated in FIG. 4 is an example of forming a web page address, and the web page address may be formed by using various methods.

When the client 240 inputs the web page address in order to view the documents included in the document box 121 as a web page, a web browser of the client 240 analyzes the web page address, connects to a server indicated by the web page address according to the result of the analysis, and requests the server to transmit data. When the image forming apparatus 100 is the server, the image forming apparatus 100 provides the data forming a web page in response to the request.

Referring back to FIG. 3, the web page name 303 represents the name of the web page that corresponds to the selected document box 205 of FIG. 2 and a user may select the name edit icon 304 so as to edit the web page name 303.

The document list 305 represents a list of the documents stored in the selected document box 205 of FIG. 2. The document list 305 includes thumbnails representing the characteristics of the documents, the names of the documents, the created dates of the documents, and the titles of the documents. Also, the user checks or un-checks the mark “/” so that a checked document is provided as a web page and an unchecked document is not provided as a web page. Checking and un-checking may be performed by selecting the document through the user interface unit 150. For example, according to the basic setting of the image forming apparatus 100, when all documents included in the document box 121 are to be provided to a web page, the user may select the documents that are not provided as a web page by un-checking the documents that are not provided as a web page.

The selected document 306 is the document for which a user requests detailed information from among the documents that are to be provided as a web page. The user selects the document and the detailed information about the selected document 306 may be displayed on the information display region 307 by the user. The information displayed on the information display region 307 may include the selected document 306's title, name, created date, and URL that correspond to the document. The title of the selected document 306 may be set to the name of the document or a part of the contents obtained as a result of optical character recognition (OCR) according to the basic setting. Also, the user may directly input the title of the document by selecting the title edit icon 308.

The title of the document may be set to a combination of characters or marks that may represent the contents of the document. The title of the document may be set as the name of the document or the character obtained by performing the OCR on the document converted into image data.

The OCR coverts character images into machine-readable characters. The converter 143 converts the documents into image data and performs the OCR on the converted image data. The OCR is performed for a set region of the document. For example, the controller 130 performs the OCR for the first sentence of the document or at least one word forming the first sentence of the document and sets the title of the document as the character obtained by performing the OCR. Accordingly, even if the user does not set the title of the document, the title of the document may be set to the character that implicitly represents the contents of the document and thus the document may be easily managed by the user.

The user selects the “next” icon 309 so as to select layout information about the web page which provides the document box 121 as a web page. In response to the selection by the user, the controller 130 displays the layout information about the web page set in the image forming apparatus 100 on the user interface unit 150.

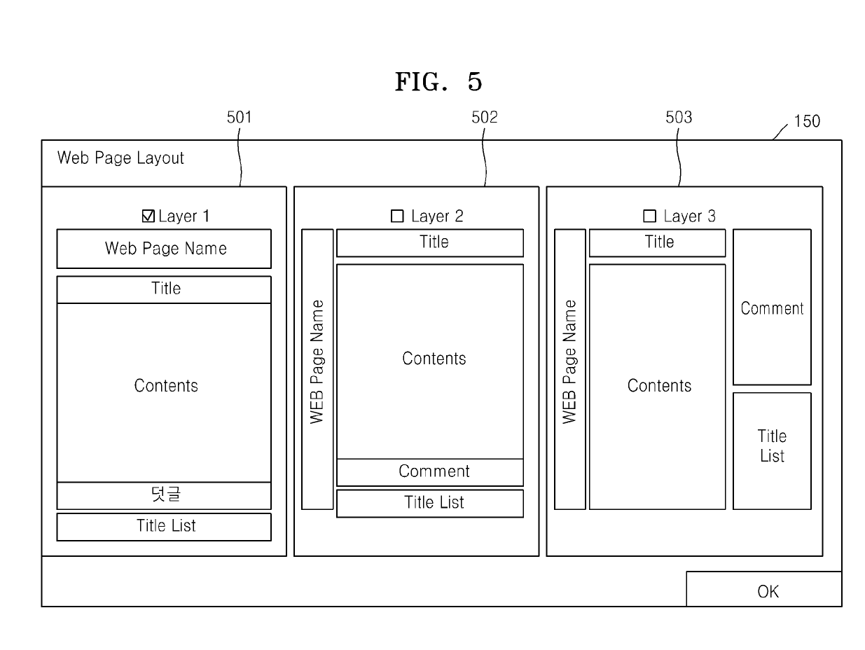

The layout information displayed on the user interface unit 150 is illustrated in FIG. 5.

FIG. 5 illustrates a selection screen to select the layout information according to an embodiment of the present general inventive concept. Referring to FIG. 5, three pieces of layout information are displayed on the user interface unit 150. Layer 1 501, layer 2 502, or layer 3 503 is selected so as to select the layout of the web page. The layout information illustrated in FIG. 5 is only an example and additional or different layout information may be displayed.

The layer 1 501 is now described as an example. When the layer 1 501 is selected and an “OK” icon is selected, a setting to provide the documents included in the document box 121 as a web page is completed. The layout of the web page representing the documents included in the document box 121 is formed as the layer 1 501. That is, “web page name” is displayed at the top of the web page and information of the documents included in the document box 121 is displayed under the “web page name”. For example, the title and contents of the first document may be displayed and a list of titles of the documents after the first document may be displayed. The client may view the title and contents of the documents displayed as a web page and input additional information in the web page. The additional information may include at least one of the group consisting of replies added to the web page, comments, and trackback information.

Referring back to FIG. 2, the user selects the document box addition icon 204 so as to additionally select at least one document box which corresponds to the address of the web page to provide documents included in the document box 121 as a web page.

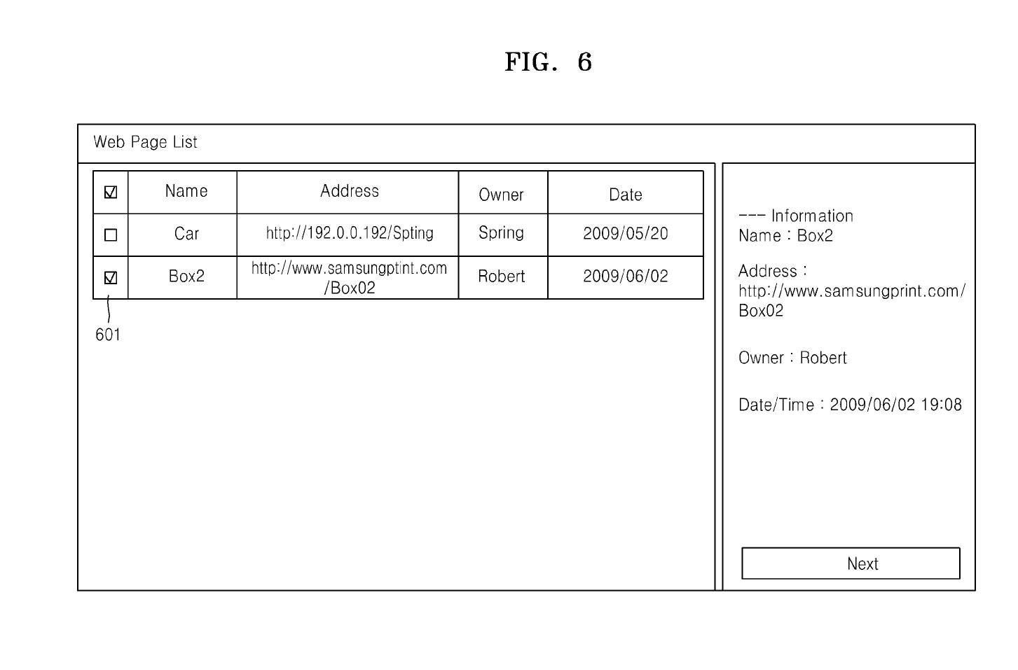

For example, the user additionally selects at least one document box displayed in the document box list 201 and selects the document box addition icon 204. The user interface unit 150 displays a list of web pages set in the image forming apparatus 100 in response to the selection by the user. A list of web pages displayed on the user interface unit 150 is illustrated in FIG. 6.

FIG. 6 illustrates a list of web pages according to an embodiment of the present general inventive concept. Referring to FIG. 6, the user selects a web page to which the document box is added from among the web pages displayed in the list of web pages. As described above, the user selects any one web page in the list of web pages displayed on a display panel of the user interface unit 150 so that a document box may be added to a selected web page 601. That is, the web page creator 142 stores information of the document box to be added in the storage location of the storage unit 120 which corresponds to the web page 601 selected by the user so as to display the documents included in the plurality of document boxes 121 on one web page.

Accordingly, since the documents included in the plurality of document boxes 121 having similar attributes with each other are provided as one web page, sharing of the documents may be smoothly performed.

The GUI is a user interface formed of graphics and may include icons, characters, and marks. The selection screens illustrated in FIGS. 2-3 and FIGS. 5-6 may be displayed on the user interface unit 150. The user may input information to be selected by using a method of touching icons of the selection screen displayed on the user interface unit 150. In addition, the selection screen having the above function is displayed on a web user interface (UI) according to the image forming apparatus driver 220 of the host device 200 that is connected to the image forming apparatus 100 and selected information may be input to the image forming apparatus 100 from the host device 200. The selection screens illustrated in FIGS. 2-3 and FIGS. 5-6 are only an example and various selection screens to perform the above function may be used.

Referring back to FIG. 1A, the converter 143 converts the documents stored in the document box 121 into image data having an image form to represent the documents as a web page. Here, the documents stored in the storage unit 120 may be created to perform printing, scanning, and faxing in the image forming apparatus 100 or may be received from the host device 200 or a fax machine connected to the image forming apparatus 100.

More specifically, the documents stored in the storage unit 120 exist as printing data or fax data according to the task performed in the image forming apparatus 100. Accordingly, the converter 143 converts the stored documents by using an emulator. When the documents stored in the storage unit 120 exist as image data according to the result of the scanning, the converter 143 may not perform conversion.

The documents may be converted into image data of bitmap (BMP) format according to the result of the emulator. The image data to represent the documents as a web page according to the current embodiment is not limited to a BMP format and may have various formats such as Graphic Interchange Format (GIF), Joint Photographic Coding Experts Group (JPEG), and Tagged Image File Format (TIFF) according to a compression method. Also, it would have been obvious to one of ordinary skill in the art that the format of image data is not limited thereto and the image data may have any format which may represent images.

When the documents included in the document box 121 are converted into image data, the storage unit 120 stores the converted image data in the location which corresponds to the web page. That is, the storage unit 120 adds the converted image data in the database 122 which corresponds to the document box 121. Here, the converter 143 compares the capacity of the converted image data with a predetermined value. When the capacity of the converted image data is greater than the predetermined value, the image data is divided and the storage unit 120 adds the divided image data in the database 122, so that loading time of the client 240 may be kept to a minimum. That is, the converted image data is added to the database 122 while being divided into parts or sections and the divided image data may be provided to the client in response to the request of the client. Accordingly, the loading time of the client may be reduced. Also, the client may view some part of the divided image data in advance so that the client is not bored during the loading time of the client.

For example, when the client inputs a URL of the document box 121 to be viewed, the web page creator 142 searches for the data of the database 122 and provides the information of the document box 121 which corresponds to the URL requested by the client to the client. The web page creator 142 forms the image data of the documents that are included in the document box 121 existing in the database 122 as a web page according to the form selected by the user in the database 122.

The web page creator 142 creates information in the database 122 as a web page by using a personal homepage tool, such as a hypertext preprocessor (PHP). The PHP is a web programming language which is a script language of a server that forms a dynamic web page. The PHP may be included in HTML, which forms a web page. The web page creator 142 may be connected with the database 122 by using the PHP and may provide the document box 121 as a web page in response to the request of the client.

Also, the client 240 may input additional information such as comments to the web page, the communication interface unit 110 of the image forming apparatus 100 may receive the additional information, and the web page creator 142 may add the additional information to the database 122 which corresponds to the document box 121 by using the PHP. In addition, according to an environment of use, the controller 130 creates a second document including additional information in a first document which corresponds to a web page, and the storage unit 120 may store the created second document in the location corresponding to the web page. Accordingly, a user may view the second document including the additional information through the user interface unit 150.

The PHP is only an example for forming a web page according to the current embodiment and a web page may be created by using various methods in addition to the PHP.

Also, the client 240 may copy or download the documents provided as a web page. When the web page is a blog, the client may conveniently copy the documents provided as notice items of the blog to the client's blog.

When new documents are added to the document box 121, the web page creator 142 adds the new documents to the database 122 that corresponds to the document box 121 and the communication interface unit 110 provides image data converted from the added documents in response to the request of the client so that a web page for the added documents may be displayed to the client. Here, when the new documents are added to the document box 121 according to an environment of use, the new documents may be created as a web page, or a user of the document box 121 may select whether the new documents are created as a web page through the user interface unit 150.

In addition, when security such as password is set for the documents included in the document box 121, the web page creator 142 creates the web page so as to display the security setting in the web page. That is, the web page may be formed so that the contents of the security set documents may be viewed only when a password set by a user is input.

Accordingly, the documents stored in the image forming apparatus 100 may be represented as the web page having a layout that is familiar with the client. The web page according to the current embodiment includes blogs and homepages. That is, the web page creator 142 may provide the documents included in the document box 121 in various forms of web pages such as blogs or homepages according to an environment of use.

When the documents included in the document box 121 are to be shared with users of other users, a user of the image forming apparatus 100 may inform the other users of the web page address set in correspondence with the document box 121. Users who are to view the documents included in the document box 121 may visit the web page indicated by the address and may conveniently view the documents included in the document box 121.

In order to share the documents stored in the image forming apparatus 100, the user may send e-mails by adding the documents and sharers one-by-one or may upload the documents to a server. The other users may download the documents added in the received e-mails or download the documents uploaded to the server. In such process, the documents stored in the image forming apparatus 100 may be essentially copied, e-mailing may not be available according to the storage capacity of the sharers, and shares added to e-mail receivers may be included each time shares are added. Also, each time new documents are added to the document box 121, the above process needs to be repeatedly performed and when the documents included in the document box 121 are to be viewed, the documents may be opened to identify the contents.

According to the image forming apparatus 100 which provides the documents stored in the document box 121 as a web page, unnecessary documents in the image forming apparatus 100 may not be copied, and the title of the document and some parts of the contents of the document are provided as a web page so that the title and contents of the documents may be viewed at the same time. In addition, when new documents are added to the document box 121, an unnecessary process need not be repeatedly performed and the added documents may be displayed on a web page by a simple operation. When additional information such as comments is displayed on the web page by sharers, the document including the additional information may be stored in the image forming apparatus 100.

In addition, when the web page is provided as a blog or a homepage, the track back function is provided so as to provide a link to other blogs. The user of the document box 121 may easily identify information of the document sharers through the management of blogs.

The user interface unit 150 acquires an input signal from the user and displays the information to the user. For example, the user interface unit 150 may include any input and output devices such as a display panel, a mouse, a keyboard, a touch screen, a monitor, and a speaker prepared in the image forming apparatus 100.

The image forming unit 161, the fax unit 162, and the sending function performing unit 163 perform various functions of the image forming apparatus 100. For example, the image-forming unit 161 may include photoconductive drums, light-emitting devices, ink-emitting devices, toner cartridges, rollers, and/or recording media to perform any one of printing, scanning, and copying operations. In other words, although the image-forming apparatus 100 may include a display, the image-forming apparatus 100 may also transfer an image to a tangible recording medium, and not just display an image on a display, such as a monitor or screen. The fax unit 162 may include a fax modem, rollers, light emitting units, a fax interface, and other supporting hardware to send and receive faxes of documents. The sending function performing unit 163 may include memory, logic, modems, and communication ports or transceivers to transmit the documents to external devices such as a server, a mobile storage medium, and a computer system.

The host device 200 includes a communication interface unit 210 and the image forming apparatus driver 220, and the image forming apparatus driver 220 may include a storage option setting unit 221 and a web page creating option setting unit 222.

The communication interface unit 210 sends and receives data to and from the image forming apparatus 100 through the network 400. That is, in order to provide the document box 121 as a web page, the communication interface unit 210 sends printing data, storage option information, and web page creating option information to the image forming apparatus 100.

The host device 200 that is connected to the image forming apparatus 100 having at least one document box 121 sets a storage option for storing the document in the document box 121 included in the image forming apparatus 100 and sets a web page option for creating the web page that corresponds to the document box 121.

The storage option setting unit 221 stores the printing data in the document box 121. The printing data to be stored in the document box 121 included in the image forming apparatus 100 is created and a storage option for storing the printing data in the document box 121 according to the attribute of the printing data is set. The storage option includes selecting any one of the plurality of document boxes 121 or selecting any one of the various storing methods for the document boxes 121.

In addition, the image forming apparatus driver 220 may create the document box 121 in the image forming apparatus 100 and set a storing option for storing the printing data in the created document box 121.

The web page creating option setting unit 222 sets a web page creating option for creating the web page which corresponds to the document box 121. That is, various forms of web UIs as illustrated in FIGS. 2-3 and FIGS. 5-6 are used to set an option for creating the web page which corresponds to the document box 121.

In addition, the host device 200 may be a client which displays web pages provided from the image forming apparatus 100.

The storage option setting unit 221 and the web page creating option setting unit 222 may each include one or more processors, memory chips, and supporting logic to store computer programs and to execute the computer programs to perform the storage-option-setting and web-page-creating-option-setting functions.

FIGS. 1B-1D illustrate various arrangements of the image-forming system 10 according to the present general inventive concept.

FIG. 1B illustrates an image-forming system 10 including the image-forming apparatus 100, host device 200, a web server 230, and a client 240 each connected to the other via the network 400. Unlike the image-forming apparatus of FIG. 1A, the image-forming apparatus 100 of FIG. 1B is connected to an external web server 230 via the network 400 to create and store web pages.

For example, a user may perform an image-forming operation using the image-forming apparatus 100 or by transmitting image or document data to the image-forming apparatus 100 from the host device 200. The user may associate the image or document with a document box 121, which may be an identifier stored in the storage unit 120 to associate a plurality of documents and/or images with one another. The user may select, either at the image-forming apparatus 100 or at the host 200, to create a new webpage to include the formed image or document and/or to add the formed image or document to an existing webpage. The image-forming apparatus 100 may then transmit the image or document information to the web server 230 via the network 400 to create a new web page including the image or document or to save the data corresponding to the image or document to a web page that already exists in the web page storage 231.

Alternatively, the web page storage 231 may include data to direct the web server 230 to a storage location in the storage unit 120 of the image forming apparatus 100 when the web page is displayed. As mentioned previously regarding FIG. 1A, the image or document may be converted into an html format or other format to display the image or document on a web page. In such a case, either one of the image-forming apparatus 100 and the web server 230 may include the converter 143.

When the formed image or document is associated with a document box 121, the image or document may be automatically associated with any web page that is also associated with the document box 121. In addition, a user of a host device 200 or the image-forming apparatus 100 may configure settings so that images or documents having predetermined characteristics are automatically associated with predetermined document boxes 121, without any intervening input by a user. Alternatively, the host device 200 or image-forming apparatus 100 may include only an intervening confirmation message to determine whether a user wants to automatically associate an newly-formed image or document with predetermined document boxes 121.

Once the image or document is added to or associated with a stored web page, the stored web page may be accessed by any one of the image forming apparatus 100, the host device 200, or the client 240 to view the stored web page including any image or document data associated with the stored web page. For example, FIG. 1B illustrates a client 240 that includes a display 241, a user interface 242 to receive user input, and a data interface 243 to communicate with the network 400 to transmit data to and from the network 400.

A user of the host device 200 may create a document and transmit the document to the image-forming apparatus 100. The image-forming apparatus may associate the document with a document box 121, convert the document to a format to be added to a web page, and transmit the converted document to the web server 230 to be stored with a pre-existing web page associated with the document box 121. A user of a client 240 may then request the document from the image-forming apparatus 100 which may transmit the request to the web server 230, the web page may be transmitted to the client 240, and the web page may be displayed on the display 241.

In FIG. 1C, the web server 230 connected to the network 400 further includes the storage unit 120 including the document box 121 and the database 122. The image-forming system 10 of FIG. 1C operates similarly to that of FIGS. 1A and 1B, except that the image-forming apparatus 100 transmits any formed documents or images to the web server 230, which associates the formed document or image with a document box 121 and a web page.

For example, a user may perform an image-forming operation using the image-forming apparatus 100 or by transmitting image or document data to the image-forming apparatus 100 from the host device 200. The image-forming apparatus 100 may communicate with the web server 230 via the network 400 to allow the user to associate the image or document with a document box 121, which may be an identifier stored in the storage unit 120 to associate a plurality of documents and/or images with one another. The user may select, either at the image-forming apparatus 100 or at the host 200, to create a new webpage to include the formed image or document and/or to add the formed image or document to an existing webpage. The image-forming apparatus 100 may then communicate with the web server to create a new web page including the image or document or to save the data corresponding to the image or document to a web page that already exists in the web page storage 231.

Once the image or document is added to or associated with a stored web page, the stored web page may be accessed by any one of the image forming apparatus 100, the host device 200, or the client 240 to view the stored web page including any image or document data associated with the stored web page. In such a case, the user may access the web page by communicating with the web server 230 directly or via the image-forming apparatus 100.

FIG. 1D illustrates an image-forming system 10 similar to that of FIG. 1A, except FIG. 1D illustrates a plurality of clients 240 connected to the network 240. As described above, any one of the clients 240 may access a document stored in a document box 121 by accessing the image-forming apparatus 100 and requesting to view a web page that corresponds to the selected document box 121. Each document associated with a web page may be public or secure, or each web page may be public or secure. In other words, settings of a web page may be configured to allow a first client 240 to access the web page and to not allow a second client 240 to access the web page. Alternatively, each of the first and second clients 240 may access the web page, but portions of the web page that correspond to different documents or images may be viewable by only a subset of the clients 240.

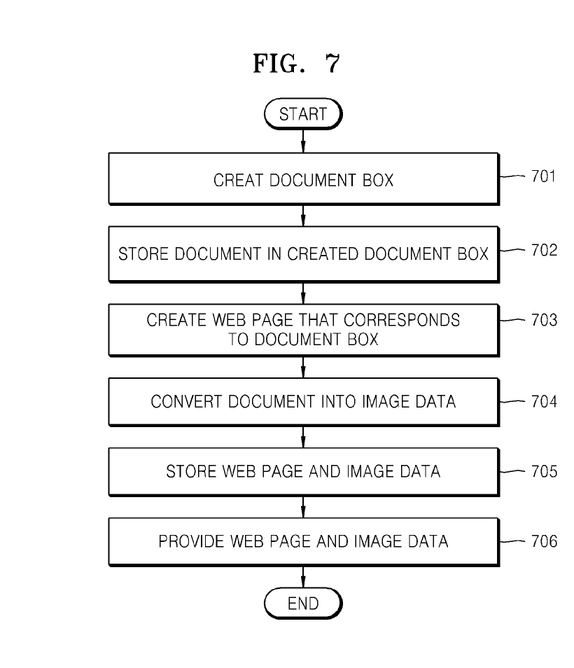

FIG. 7 is a flowchart illustrating a method of providing documents included in the document box 121 as a web page, according to an embodiment of the present general inventive concept. Referring to FIG. 7, the method of providing the documents included in the document box 121 as a web page according to the current embodiment includes operations performed in a time series in the image forming apparatus 100 of FIG. 1. Accordingly, although there are some omissions, a detailed description provided with respect to the image forming apparatus 100 of FIG. 1A is applied to the method of providing the documents included in the document box 121 as a web page.

In operation S701, the document box creator 141 creates the document box 121. A user may input information creating the document box 121 by using the user interface unit 150 of the image forming apparatus 100. Also, the document box 121 may be created by the host device 200 that is connected to the image forming apparatus 100.

In operation S702, the storage unit 120 stores at least one document in the document box 121. Here, the documents may include at least any one selected from the group consisting of fax data, scan data, e-mail data, and printing data.

In operation S703, the web page creator 142 creates the web page that corresponds to the document box 121. The information creating the web page may be input through the user interface unit 150 in the image forming apparatus 100 as illustrated in FIGS. 2-3 and 5-6. In addition, the information creating the web page may be received from the host device 200 that is connected to the image forming apparatus 100.

In operation S704, the converter 143 converts the documents stored in the document box 121 into image data having an image form to represent the documents as a web page.

In operation S705, the storage unit 120 stores the created web page and converted image data in the location corresponding to the web page.

In operation S706, the communication interface unit 110 provides the stored web page and stored image data in response to the request of the client. Accordingly, the web page creator 142 forms the document box 121 as a web page by using the information stored in the storage unit 120, in response to the request of the client, and the communication interface unit 110 transmits the information forms as the web page to the client.

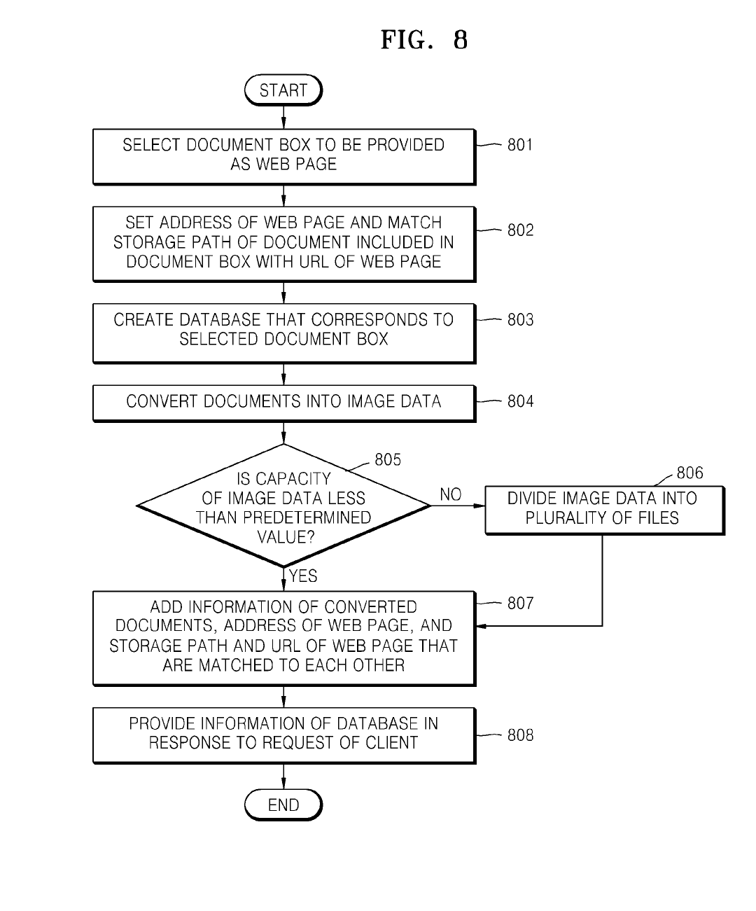

FIG. 8 is a flowchart illustrating a method of providing the documents included in the document box 121 as a web page in consideration of the capacity of the documents, according to an embodiment of the present general inventive concept.

In operation S801, a user selects at least one document box 121 which is to be provided as a web page through the user interface unit 150. The user selects the document box 121 by selecting an input icon of a display panel, which is the user interface unit 150.

In operation S802, the web page creator 142 sets an address of the web page to provide documents included in the document box 121 selected by the user as the web page and matches the storage paths of the documents included in the document box 121 with an URL of the web page. The user may edit the address of the web page through the user interface unit 150.

In operation S803, the web page creator 142 creates the database 122 which corresponds to the document box 121 selected by the user. The database 122 may exist in the storage unit 120. However, when the database 122 is previously created and exists in the image forming apparatus 100, operation 803 may not be performed.

In operation S804, the converter 143 converts the documents into image data.

In operation S805, the converter 143 compares the capacity of the image data with a predetermined value. Here, the predetermined value may be 1 Mbyte so that the loading time of the client may be prevented from being extended due to the high capacity of the image data. According to the result of the comparison, if the capacity of the image data is less than the predetermined value, operation 807 is performed; however if the capacity of the image data is greater or equal than the predetermined value, operation 806 is performed.

In operation S806, the converter 143 divides the image data into a plurality of files so that the loading time of the client may be reduced.

In operation S807, the storage unit 120 adds the image data, the address of the web page, and the storage paths of the documents and URL information of the web page that are matched to each other to the database 122.

In operation S808, the communication interface unit 110 provides the information of the database 122 to the client in response to the request of the client.

FIG. 9 illustrates that the document box 121 is represented as a web page, according to an embodiment of the present general inventive concept. Referring to FIG. 9, a GUI 901 indicating the document box 121 displayed on the user interface unit 150 of the image forming apparatus 100 and the web page 904 displayed on a display of the client are illustrated.

In FIG. 9, the document box 121 represented by the GUI 901 has the name “Box02” and includes two documents. In addition, the documents are set to be displayed on the web page having an URL of “http://www.samsungprint.com/Box02”.

When the client inputs the URL “http://www.samsungprint.com/Box02”, the web page 904 as illustrated in FIG. 9 is displayed. When documents having the titles of conference records 902 and seminar 903 are stored in the GUI 901 which represents the document box 121, a title 905 of the document displayed as “conference records” with respect to the conference records 902, which is the first document, and contents 906 of the document are displayed on the web page 904. Also, a title 907 of the document displayed as “seminar” with respect to the seminar 903, which is the second document, and contents 908 of the document are displayed on the web page 904. The client may add the comments to the web page 904 and the added comments are added to the database 122 of the image forming apparatus.

Therefore, the web pages are provided by each document box 121 that is classified according to its attributes so that the documents in the image forming apparatus 100 may be conveniently managed. Sharers may view the documents included in the document box 121 by simply inputting an URL and may easily perform copying and downloading of the necessary documents.

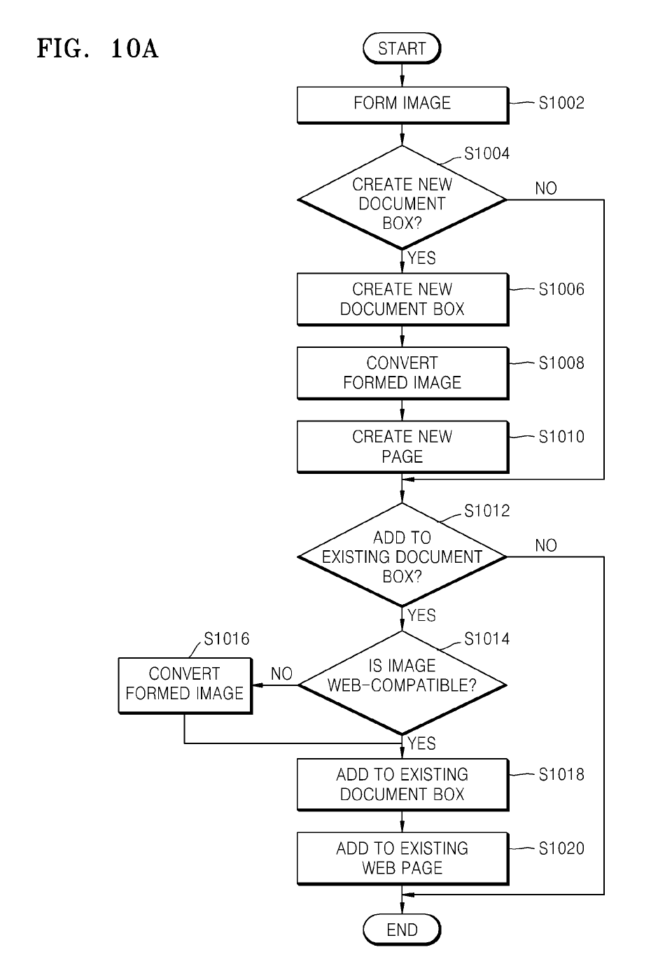

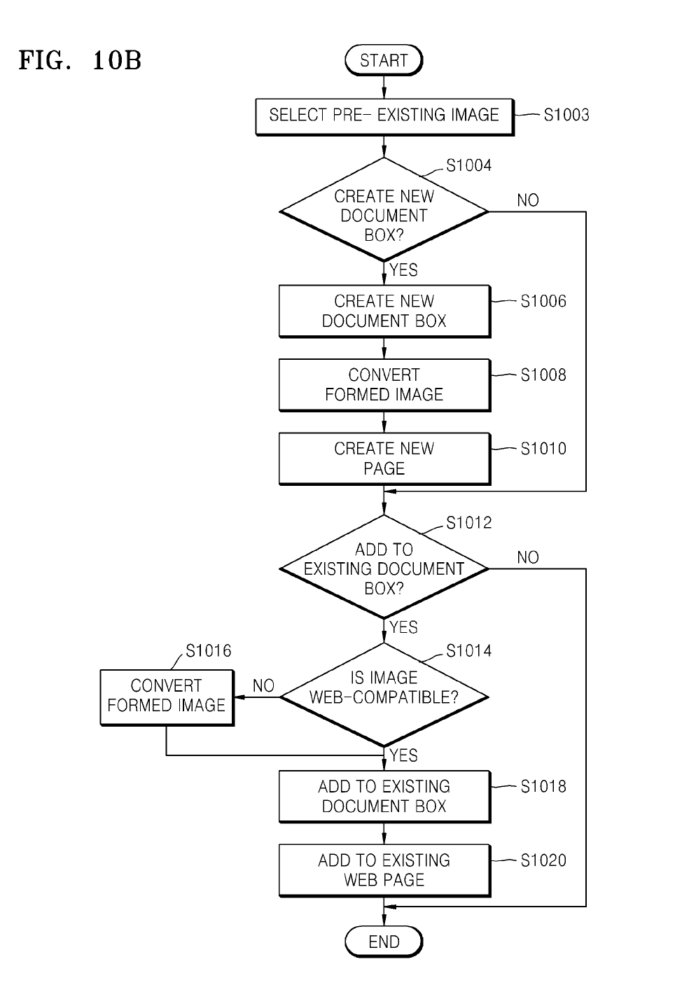

FIGS. 10A and 10B illustrate flow diagrams illustrating methods of associating documents and images with documents boxes according to the present general inventive concept.

In FIG. 10, an image may be formed in operation S1002. The image may include a photograph, graphic, or document and may be represented by data of various file types. For example, the “image” may be a digital file representing characters that may be displayed on a display to be viewed by users. Alternatively, the “image” may be a digital file representing a scanned, faxed, or copied image, or any other digital file representing an image viewable by a user.

In operation S1004, a user may choose to create a new document box with which the image may be associated. The document box may be a predetermined area of a digital storage medium, such as a memory chip. Alternatively, the document box may be bits of data that may be attached to the formed image file to associate the formed image file with any other documents that also include the bits of data. In other words, a user may choose to create a new document box named “box 1,” and in operation 1006 the image forming apparatus may create the new document box by generating computer code to attach bits to the formed image to associate the formed image with “box 1.” Any other formed image or document that also includes the same bits associated with “box 1” may also be considered as “in” the document box “box 1.”

In creating the new document box, the image-forming apparatus may generate a graphical user interface (“GUI”) having an image of a box and any documents or images associated with the box may be located inside the graphically-generated box.

In operation S1008, the image-forming apparatus or web server may convert the formed image into a format that may be displayed on a web page, and the image-forming apparatus or web server may generate a web page including the formed and converted image in operation 1016. The formed image may appear as web text in the web page, or may appear to be in its original format embedded in the web page. For example, if a document is generated as a .pdf file, the text in the file may appear as web text or a window may appear in the web page to display the text of the .pdf in a format associated with Adobe Reader™.

If in operation S1004, the user chooses not to create a new document box, the user may choose to add the formed image to a pre-existing document box in operation S1012. In addition, even if the user chooses to create a new document box in operation S1004, the user may still add the formed image to another pre-existing document box in operation S1012. For example, the user may be presented with a list of all existing document boxes or of existing document boxes accessible to the user, and the user may select one or more of the existing documents boxes to which the formed image may be added.

In operation S1014, the image-forming apparatus or web server may determine whether the formed image is in a format that may be displayed on a web page, and if it is not, the formed image may be converted in operation S1016. The converted formed image may be added to the selected existing document boxes in operation S1018. Then, in operation S1020, the image-forming apparatus or web server may update the existing web pages associated with the selected document boxes to include the converted formed image.

FIG. 10B is similar to FIG. 10A, except instead of forming a new image, a user may select one or more pre-existing images or documents to add to one or more document boxes. In particular, in operation S1003, a user may be presented with a list of existing formed or saved images stored in an image-forming apparatus, and the user may select one or more of the images to add to a document box.

As discusses above with respect to FIG. 10A, the one or more selected documents may then be included in a new document box and web page or in pre-existing document boxes or web pages.

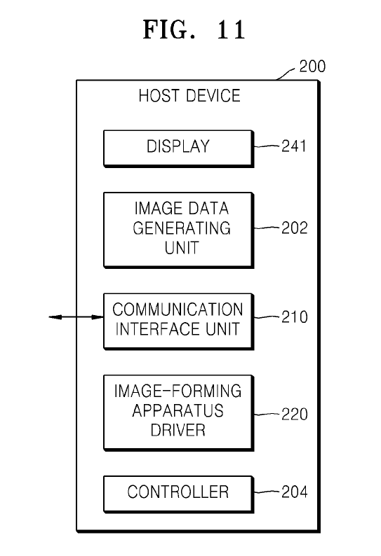

FIG. 11 illustrates an embodiment of a host device 200 according to the present general inventive concept. As discussed above, the host device 200 may include a communication interface unit 210 and an image-forming apparatus driver 220. The communication interface unit 210 may include an electronic interface with the network 400 and the image-forming apparatus 100, with additional external devices (not shown), and also with a user. For example, a portion of the communication interface unit may include a user input panel, keyboard, or other input devices to receive user input. In addition, the host 200 may include a display 241. The host may include an image-generating unit 202. The image-generating unit 202 may be part of the image-forming apparatus driver 220, or may include computer programs and files stored in memory and executed by processors or other logic to generate an image. A controller 204 may control operation of each functional unit of the host 200.

In operation, a user may input data or images via the communication interface unit 210, the data or images may be displayed on the display 241, and the data and images may be sent to the image-forming apparatus 100 to be printed on a recording medium. The host 200 may then receive one or more prompts to control operation of the image-forming apparatus 100, and the image-forming apparatus 100 may transmit web page data to the host 200 to display a web page on the display 241 with the image data transmitted from the host 200. Alternatively, the host may display a web page transmitted from the image forming apparatus 100 that corresponds to image data transmitted from a separate host 200 or client 240.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

According to the present general inventive concept, a user of an image forming apparatus 100 may share documents included in a document box 121 with other sharers in a web page form and the sharers may view the web page so that a title and contents of the documents may be viewed at the same time. In addition, as the documents included in the document box 121 are provided as a web page, the documents may be viewed in an environment that is familiar with the user and the documents stored in the image forming apparatus 100 may be shared without further operation by the user. Moreover, the image forming apparatus 100 creates the documents including information added to the documents by the sharers who view the web page so as to interact with the sharers.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. A method of providing at least one document box in an image forming apparatus and at least one document stored in the document box as a web page, the method comprising:
creating the at least one document box;
storing at least one document in the at least one document box;
creating a web page that corresponds to the at least one document box;
converting the at least one document stored in the at least one document box into image data to display on the web page;
storing the created web page and the image data in a location corresponding to the web page in the image forming apparatus; and
providing at least one of the stored web page and the stored image data in response to a request of a client.

2. The method of claim 1, wherein the at least one document comprises at least one selected from a group consisting of fax data, scan data, e-mail data, and printing data.

3. The method of claim 1, wherein creating the web page includes using a host device that is connected to the image forming apparatus or a user interface unit included in the image forming apparatus to create the web page.

4. The method of claim 1, wherein the creating of a web page comprises:
setting an address of the web page; and
matching a storage path of the at least one document stored in the document box with a uniform resource locator (URL) of the web page, and
wherein in the storing of the created web page, the set address of the web page and matching information are stored.

5. The method of claim 4, wherein the address of the web page is created by using at least one of an Internet Protocol (IP) address of the image forming apparatus, identification information of a user, attributes of the at least one document, and a storing location of the at least one document box.

6. The method of claim 4, wherein in the storing of the created web page, the web page is stored in a location corresponding to the set address of the web page.

7. The method of claim 1, further comprising:
receiving information that is to be added to the web page by a client that displays the web page represented by using the provided web page and image data,
wherein in the storing the at least one document, a second document to which the received information is added to a first document that corresponds to the web page viewed by the client is stored.

8. The method of claim 1, wherein in the creating of the web page, the web page is created according to layout information input by the user.

9. The method of claim 1, wherein in the creating of the web page, the web page is created to display a title and some part of contents of the at least one document.

10. The method of claim 9, wherein the title of the document comprises a name of the at least one document and some part of the contents of the at least one document obtained by performing optical character recognition (OCR) on the at least one document.

11. An image forming apparatus comprising at least one document box, the apparatus comprising:
a document box creator to create the at least one document box;
a web page creator to create a web page that corresponds to the at least one document box;
a converter to convert at least one document stored in the at least one document box into image data having an image form to represent the at least one document as the web page;
a storage unit to store the at least one document in the at least one created document box, and to store the created web page and the image data in a location corresponding to the web page; and
a communication interface unit to provide at least one of the stored web page and the stored image data in response to a request of a client.

12. The apparatus of claim 11, wherein the at least one document comprises at least one of fax data, scan data, e-mail data, and printing data.

13. The apparatus of claim 11, wherein the web page creator sets an address of the web page and matches a storage path of the at least one document stored in the at least one document box with a uniform resource locator (URL) of the web page, and
wherein the storage unit stores the set address of the web page and matching information in a location corresponding to the web page.

14. The apparatus of claim 13, wherein the address of the web page is created by using at least one of an Internet Protocol (IP) address of the image forming apparatus, identification information of a user, attributes of the at least one document, and a storing location of the at least one document box.

15. The apparatus of claim 13, wherein the storage unit stores the set address of the web page and matching information in a location corresponding to the set address of the web page.

16. The apparatus of claim 11, wherein the web page creator creates the web page according to layout information input by the user.

17. The apparatus of claim 11, wherein the web page creator creates the web page to display a title and some part of contents of the at least one document.

18. The apparatus of claim 11, wherein the storage unit comprises a web server to provide the web page.
